(19) United States
(12) Patent Application Publication
(10) Pub. No.: US 2013/0346145 A1
(43) Pub. Date: Dec. 26, 2013

(54) COMMUNICATION DEVICE, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: Haruki Sato, Tokyo (JP)

(21) Appl. No.: 13/919,131

(22) Filed: Jun. 17, 2013

(30) Foreign Application Priority Data
Jun. 22, 2012 (JP) 2012-140800

(51) Int. Cl. G06Q 20/14

(52) U.S. Cl. CPC G06Q 20/145
USPC 705/7.29

(57) ABSTRACT

A communication device that is capable of reducing ineffectual process and load by checking continuity of a SIP session depending on whether a network charges a fee or not. The communication device communicates with another communication device by a predetermined communication protocol. A determination unit determines whether a network used for communication charges a fee or not. A checking unit checks whether the communication continues when the determination unit determines that the network charges a fee. A communication control unit finishes the communication when the checking unit determines that the communication does not continue.

### BACKGROUND OF THE INVENTION

1. Field of the Invention

The present invention relates to a communication device that communicates with another communication device on a network by a predetermined protocol, a control method therefor, and a storage medium storing a control program therefor.

2. Description of the Related Art

The SIP (Session Initiation Protocol) that establishes a virtual session (SIP session) between communication devices on a network for communicating various data has spread. The SIP is used for an IP phone, IPFAX, etc. For example, when a client terminal performs IPFAX with a destination client terminal via a network, the client terminal first establishes a SIP session between the terminals using the SIP, and then, transmits and receives facsimile data. At this time, an address resolution is performed and a communication state is managed on a network. Moreover, charging information is also collected when a fee is charged on the communication on the network. The charging starts when the SIP session is established, and finishes when the SIP session is disconnected.

However, even if the normal communication becomes impossible due to a failure or a malfunction of the client terminal or disconnection by a pullout of network cable, etc., a communication service cannot grasp those conditions unless the client terminal disconnects the SIP session. Moreover, since the client terminal cannot immediately detect that the client terminal at the other side has fallen into disconnection etc., the SIP session is continued until a data-transmission timeout occurs. As a result, when charging information is collected on the network in a service like VoIP (Voice over IP) or a data communication, the user of the client terminal may be overcharged.

A method to solve the above-mentioned problem is proposed in Japanese Laid-Open Patent Publication (Kokai) No. 2008-244840 (JP 2008-244840A)), for example. According to the method, a repeating installation is installed between the client terminal and the network charging a fee to determine continuity of the SIP session periodically. When it is determined that continuity is lost, the SIP session is disconnected.

There is a network that charges a fee on communication and a network that does not charge a fee on communication. When the network that charges a fee is used to communicate, a check of the continuity of the SIP is necessary to prevent useless fee collection. On the other hand, when the network that does not charges a fee is used to communicate, the necessity to check the continuity is comparatively small.

The repeating installation at the communication service side checks the continuity in JP 2008-244840A. On the other side, when the continuity of the SIP session is checked at the terminal side, the necessity of checking the continuity varies depending on the type of the network to which the terminal is connected. If the continuity is always checked in such a configuration, ineffectual process and load are required for checking the continuity when using the network that does not charge a fee, particularly.

### SUMMARY OF THE INVENTION

The present invention provides a communication device, a control method therefor, and a storage medium storing a control program therefor, which are capable of reducing ineffectual process and load by checking continuity of a SIP session depending on whether a network charges a fee or not.

Accordingly, a first aspect of the present invention provides a communication device that communicates with another communication device by a predetermined communication protocol, comprising a determination unit configured to determine whether a network used for communication charges a fee or not, a checking unit configured to check whether the communication continues when the determination unit determines that the network charges a fee, and a communication control unit configured to finish the communication when the checking unit determines that the communication does not continue.

Accordingly, a second aspect of the present invention provides a control method for a communication device that communicates with another communication device by a predetermined communication protocol, the control method comprising a determination step of determining whether a network used for communication charges a fee or not, a checking step of checking whether the communication continues when it is determined that the network charges a fee in the determination step, and a communication control step of finishing the communication when it is determined that the communication does not continue in the checking step.

Accordingly, a third aspect of the present invention provides a non-transitory computer-readable storage medium storing a control program causing a computer to execute the control method according to the second aspect.

The present invention reduces ineffectual process and load by checking continuity of a SIP session depending on whether a network charges a fee or not.

Further features of the present invention will become apparent from the following description of exemplary embodiments with reference to the attached drawings.

### BRIEF DESCRIPTION OF THE DRAWINGS

FIG. 1 is a view showing an example of a network environment including a multifunctional peripheral device that is an example of a communication device according to an embodiment of the present invention.

FIG. 2 is a block diagram schematically showing a hardware configuration of the multifunctional peripheral device shown in FIG. 1.

FIG. 3 is a block diagram schematically showing a software configuration of the multifunctional peripheral device shown in FIG. 1.

FIG. 4 is a view showing an example of a connected environment information list used by a connected-environment-determination module shown in FIG. 3.

FIG. 5 is a view showing an example of a UI screen for registering connected environment information into the connected environment information list shown in FIG. 4.

FIG. 6 is a view showing transmission and reception of signals and data in an IPFAX communication between the multifunctional peripheral device and a communicated destination terminal that are shown in FIG. 1.

FIG. 7 is a flowchart showing an IPFAX transmission process executed by the multifunctional peripheral device shown in FIG. 1.

FIG. 8 is a flowchart showing a continuity determination process for the SIP session executed by the multifunctional peripheral device shown in FIG. 1.

### DESCRIPTION OF THE EMBODIMENTS

Hereafter, embodiments according to the present invention will be described in detail with reference to the drawings.

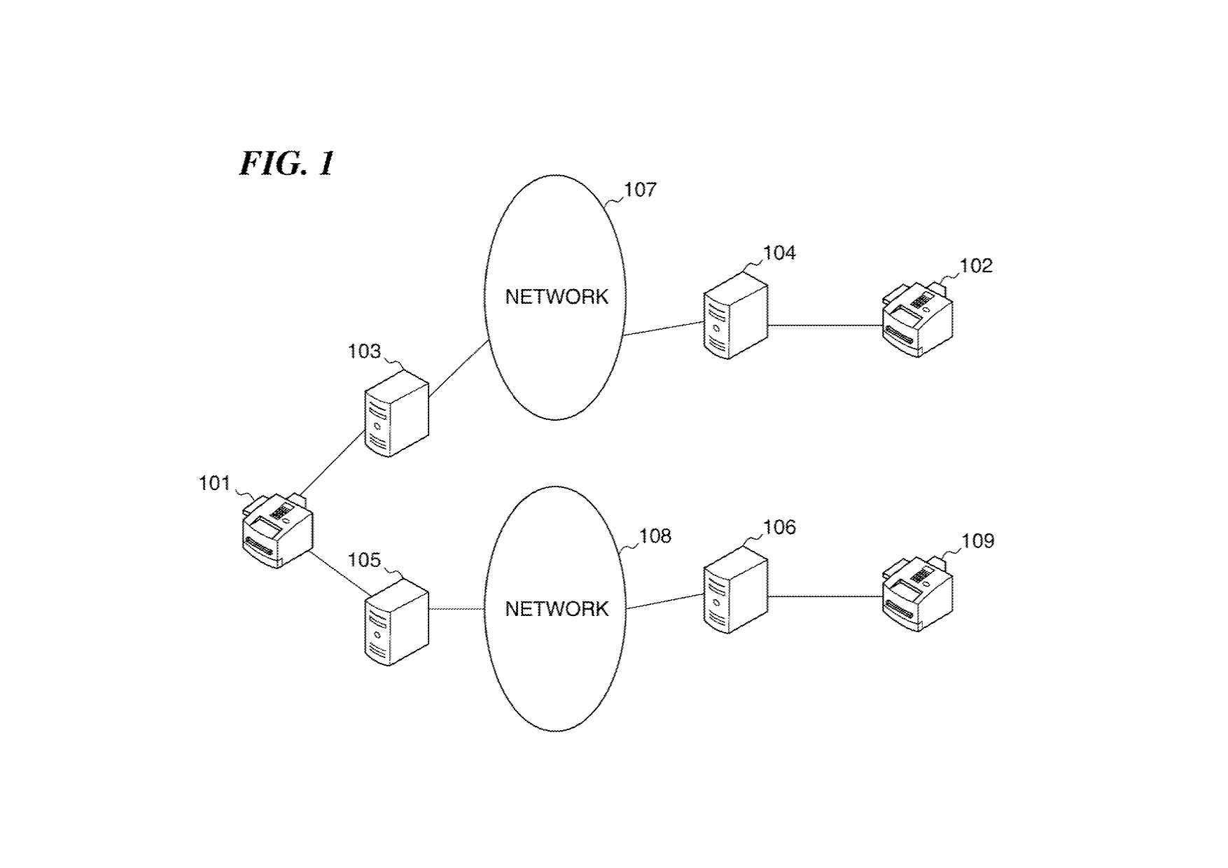

FIG. 1 is a view showing an example of a network environment including a multifunctional peripheral device 101 that is an example of a communication device according to an embodiment of the present invention.

As shown in FIG. 1, the multifunctional peripheral device 101 is provided with various functions, such as an IPFAX function, a copy function, a print function, and a scan function. Moreover, the multifunctional peripheral device 101 is connected to networks 107 and 108 through gateway devices 103 and 105, respectively. It should be noted that multifunctional peripheral device 101 may be connected to three or more networks.

Multifunctional peripheral devices 102 and 109 are connected to the networks 107 and 108 through gateway devices 104 and 106, respectively, in the same manner as the multifunctional peripheral device 101. Each the multifunctional peripheral devices 102 and 109 is provided with various functions, such as an IPFAX function, a copy function, a print function, and a scan function, like the multifunctional peripheral device 101. The IPFAX function with which the multifunctional peripheral devices 101, 102, and 109 are provided performs Internet FAX communication that is compliant with T.38 in the ITU-T recommendation. The multifunctional peripheral devices 101, 102, and 109 mutually transmit and receive data by an IPFAX communication etc. Communication devices more than the illustrated example may be connected through gateway devices.

Communications through the networks 107 and 108 are controlled by the IP (Internet Protocol), and the multifunctional peripheral devices 101, 102, and 109 perform the IPFAX communication that is compliant with the IP. Moreover, the networks 107 and 108 perform call control (session control) using the SIP (Session Initiation Protocol). In this call control, user agents (UA) are identified by SIP URI (Uniform Resource Identifier), and are able to communicate without considering a device IP address of the transmission destination. Then, a SIP session is established by exchanging SIP messages between UAs. In the embodiment, all the multifunctional peripheral devices 101, 102, and 109 operate as UAs.

The network 107 charges a fee based on information described in an SDP included in a SIP message. That is, a fee corresponding to operating time (communicating time) is charged on a user, when the user communicates through the network 107. On the other hand, the network 108 does not charge a fee corresponding to operating time (communicating time). Even if a user pays specified amount of fee as a basic contract of a communication service, unless a fee is charged corresponding to operating time (communicating time), the network shall not charge a fee in the specification.

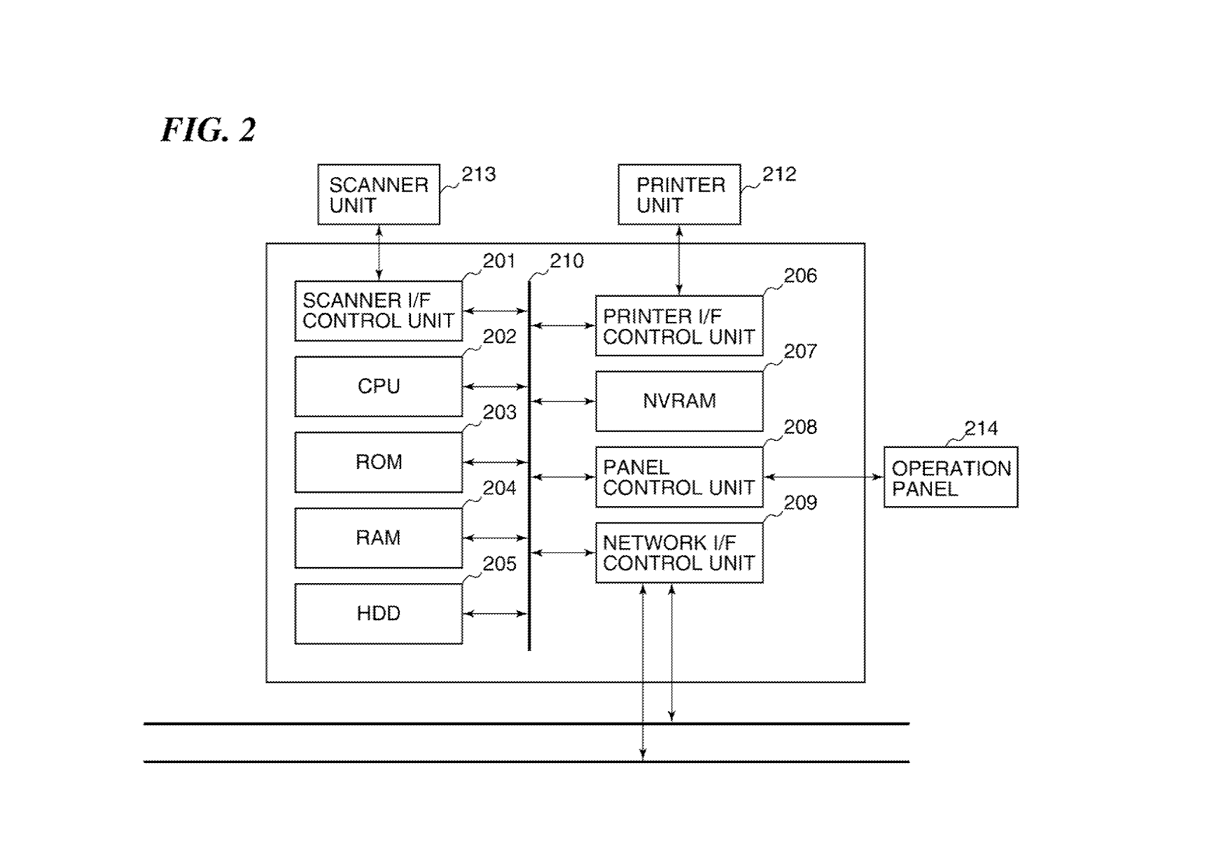

FIG. 2 is a block diagram schematically showing a hardware configuration of the multifunctional peripheral device 101 shown in FIG. 1.

A CPU 202 collectively controls accesses with various devices connected to a system bus 210 based on a control program stored in a ROM 203 or a hard disk (HDD) 205. Moreover, the CPU 202 outputs an image signal as output information to a printer unit 212 connected via a printer I/F control unit 206, and controls an image signal inputted from a scanner unit 213 connected via a scanner I/F control unit 201.

The ROM 203 includes a program area that stores the control program etc. executable by the CPU 202 and a data area that stores information used by the multifunctional peripheral devices.

The CPU 202 communicates with the communication devices on the networks via a network I/F control unit 209. A RAM 204 mainly functions as a main memory and a work area of the CPU 202, and is able to extend memory capacity by an option RAM connected to an add-on port (not shown).

The HDD 205 is used as a job storage area for storing an application program, font data, form data, etc., spooling a print job temporarily, and controlling the spooled job from the outside. Moreover, the HDD 205 is used as a BOX data storage area that stores image data read by the scanner unit 213 and image data of a print job as BOX data so that the image data is referred to from a network and is printed. It should be noted that an SD card, a flash memory, etc. other than the HDD 205 may be used as an external storage device.

Information about various settings set and inputted on an operation panel 214 as an operation unit is stored into a nonvolatile memory (NVRAM) 207 via a panel control unit 208. The network I/F control unit 209 performs data communication with an external network through a network cable. In this embodiment, the network I/F control unit 209 is connected to the gateway devices 103 and 105 through the different network cables.

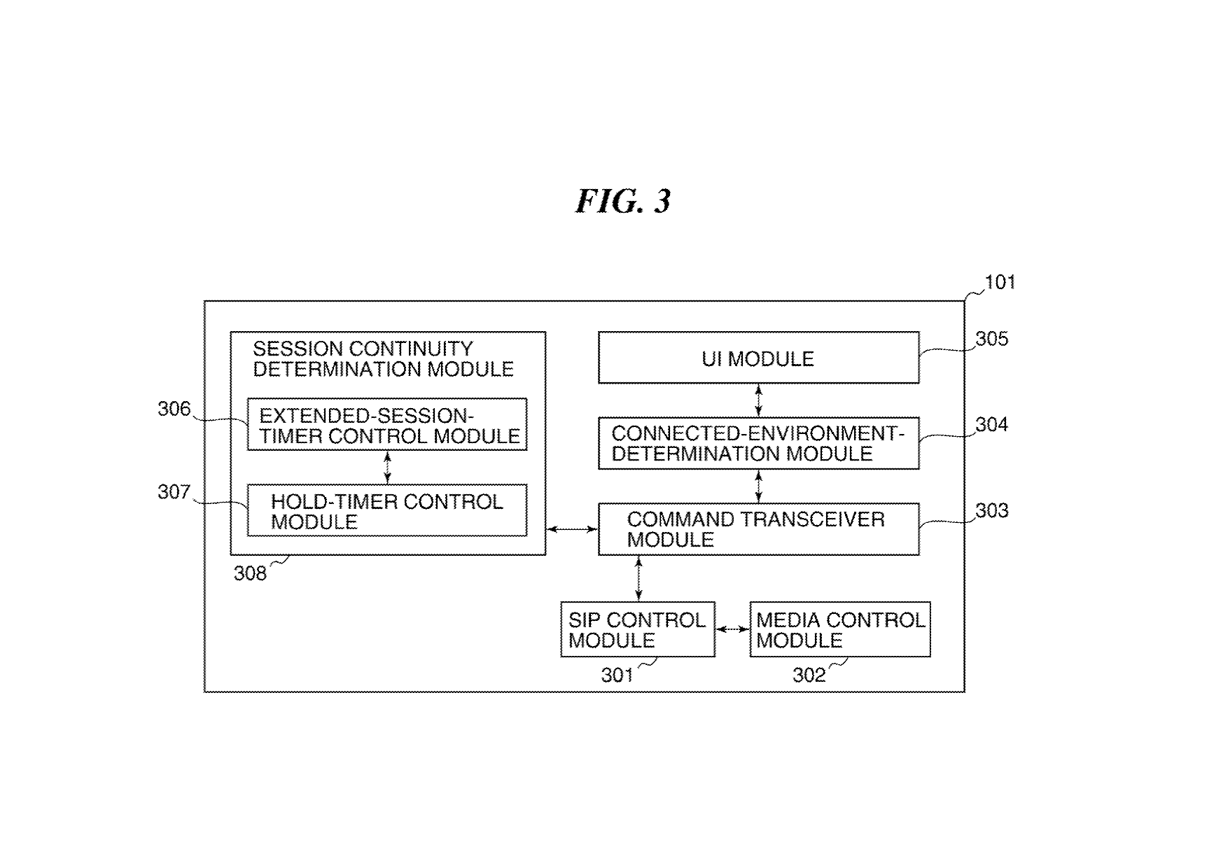

FIG. 3 is a block diagram schematically showing a software configuration of the multifunctional peripheral device 101. It should be noted that the illustrated software modules are stored in the ROM 203 or the HDD 205, are read to the RAM 204 as needed, and are executed by the CPU 202.

An SIP control module 301 controls the SIP session of the IPFAX communication. The media control module 302 transmits and receives media data of the IPFAX communication, and prints the media data as needed. A command transceiver module 303 exchanges commands for instructing respective processes with the SIP control module 301, a connected-environment-determination module 304, and a session continuity determination module 308.

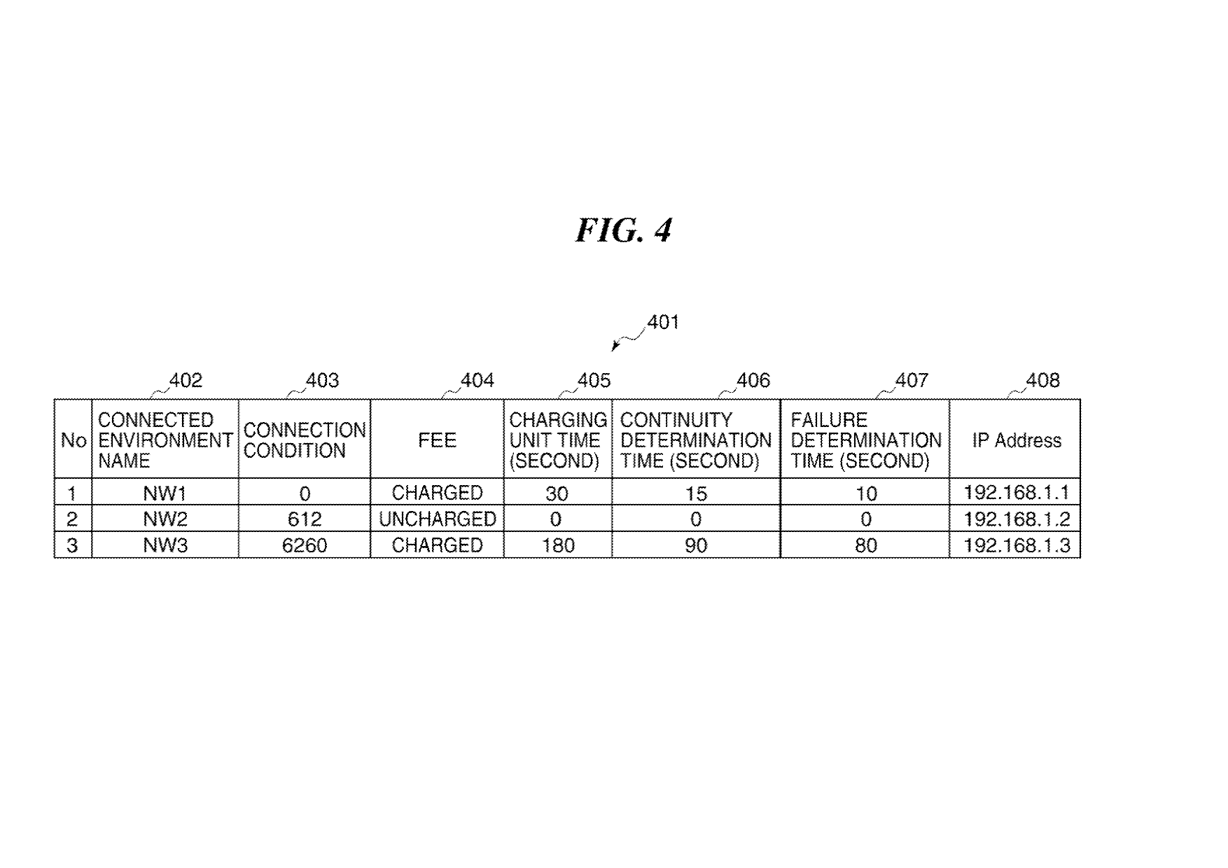

The connected-environment-determination module 304 identifies the network through which the IPFAX communication is performed based on a connected environment information list 401 shown in FIG. 4, and the SIP URI of the destination terminal of the IPFAX communication. The connected environment information list 401 holds connected environment information, which includes the presence or absence of fee collection, charging unit time, continuity determination time in consideration of the charging unit time, failure determination time, etc., as table information for every network system to which the multifunctional peripheral device 101 is connectable.

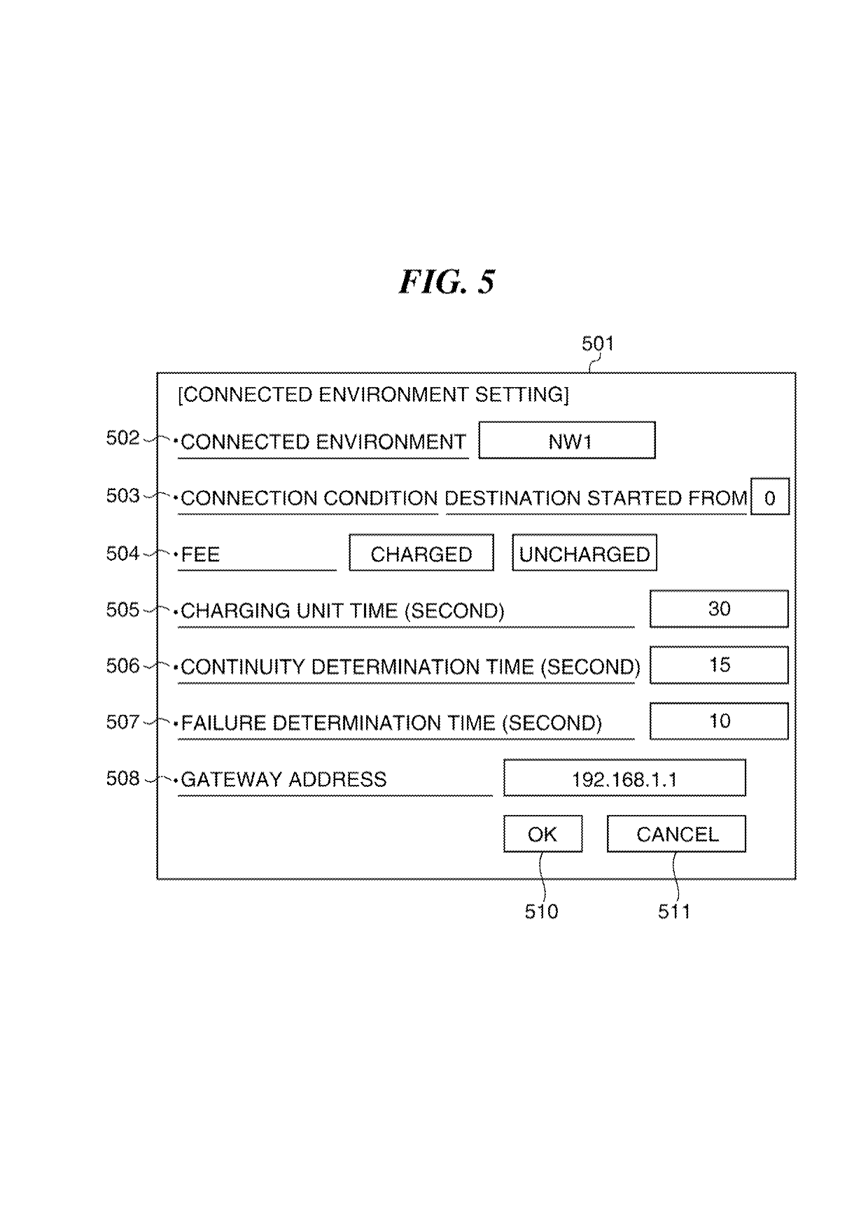

A UI module 305 controls the panel control unit 208 so as to display a connected configuration screen 501 shown in FIG. 5 on the operation panel 214. Then, the connected environment information set by a user on the connected configuration screen 501 is added to the connected environment information list 401. Moreover, the UI module 305 receives an IPFAX transmission instruction from a user, and sends the IPFAX transmission instruction to the command transceiver module 303.

The session continuity determination module 308 consists of a hold-timer control module 307 and an extended-session-timer control module 306. The hold-timer control module 307 transmits a transmission command of a Re-Invite request (response request) to the command transceiver module 303 at constant time intervals. The extended-session-timer control module 306 determines the continuity of the SIP session at constant time intervals, and transmits a SIP-session disconnecting command to the command transceiver module 303 through the SIP control module 301, when determining the continuity of the SIP session has been lost. The hold-timer control module 307 and the extended-session-timer control module 306 measure time using a standard RTC (Real Time Clock) that is standard equipment of the CPU 202.

FIG. 4 is a view showing an example of the connected environment information list 401.

The connected environment information list 401 contains a connected environment name 402, a connection condition 403, a fee 404, charging unit time 405, continuity determination time 406, failure determination time 407, and an IP address 408.

The connected environment name 402 is used to identify a connection destination network, and is “NW1”, “NW2”, or the like in the illustrated example. The connection condition 403 to a connection destination network is or the like in the illustrated example.

The fee 404 is information for discriminating whether a connection destination network charges a fee or not, and is either of “CHARGED” or “UNCHARGED” in the illustrated example. The charging unit time 405 is unit time of fee collection, and is “30 (seconds)”, “180 (seconds)”, or the like in the illustrated example. It should be noted that the charging unit time for a network that does not charge a fee is “0”.

The continuity determination time 406 is the time for determining continuity of a SIP session, and is “15 (seconds)” or “90 (seconds)” in the illustrated example. It should be noted that the continuity determination time for a network that does not charge a fee is “0”. The failure determination time 407 is used to determine whether a communication failure due to a failure or a malfunction of a communicated destination terminal or a pullout of network cable etc. occurred, and is “10 (seconds)” or “80 (seconds)” in the illustrated example. It should be noted that the failure determination time for a network that does not charge a fee is “0”. The IP address 408 of a gateway device that is connected when connecting to a network is “192.168.1.1” or the like in the illustrated example.

FIG. 5 is a view showing an example of a UI screen for registering connected environment information into the connected environment information list 401.

The connected configuration screen 501 contains a connected-environment input column 502, a connection condition input column 503, a fee selection column 504, a charging-unit-time input column 505, a continuity-determination-time input column 506, a failure-determination-time input column 507, and a gateway address input field 508.

When an OK button 510 is pushed, the information inputted or selected on the connected configuration screen 501 is registered into the connected environment information list 401 that is saved in the HDD 205 or the NVRAM 207 by the CPU 202. A push on a cancel button 511 clears the information inputted or selected on the connected configuration screen 501.

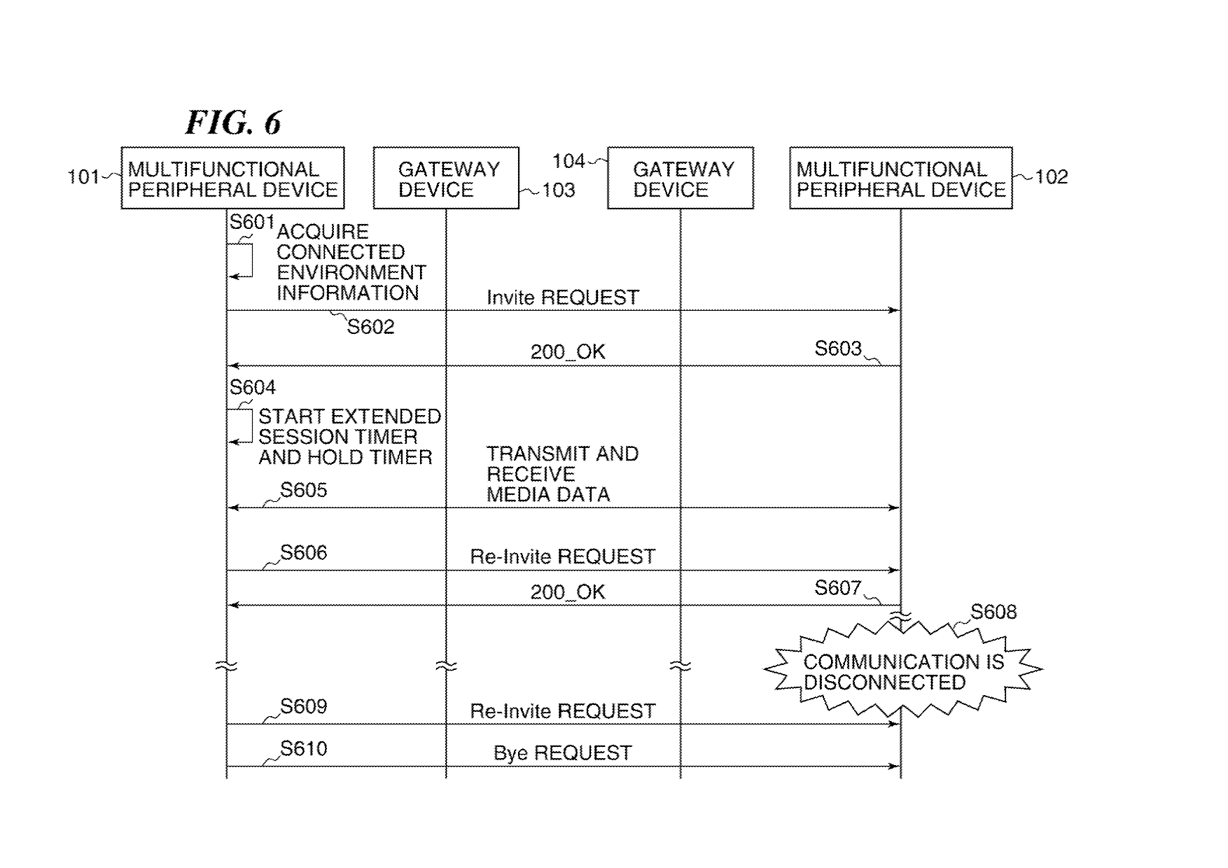

Next, a flow of the IPFAX communication between the multifunctional peripheral device 101 and the multifunctional peripheral device 102 that is a communicated destination terminal will be described with reference to FIG. 6.

FIG. 6 is a view showing an operation example of the IPFAX communication executed between the multifunctional peripheral device 101 and the multifunctional peripheral device 102 that is a communicated destination terminal.

When an IPFAX transmission job starts, the multifunctional peripheral device 101 determines a connected network corresponding to a designated transmission destination SIP URI with reference to the connected environment information list 401, and acquires the connected environment information of the connected network (S601). Then, the multifunctional peripheral device 101 transmits an Invite request to the multifunctional peripheral device 102 through the gateway device 103, the network 107, and the gateway device 104 (S602).

The multifunctional peripheral device 101 receives a 200_OK (HTTP status code 200) response that the multifunctional peripheral device 102 transmits against the Invite request, and establishes a SIP session (S603). Then, the multifunctional peripheral device 101 starts an extended session timer and a hold timer by the extended-session-timer-control module 306 and the hold-timer control module 307, respectively (S604).

Next, the multifunctional peripheral device 101 transmits and receives media data through the established SIP session (S605).

When the continuity determination time 406 has elapsed after the SIP session was established, the multifunctional peripheral device 101 transmits a Re-Invite request to the multifunctional peripheral device 102 (S606). Then, when receiving a 200_OK response within the failure determination time 407 (S607), the multifunctional peripheral device 101 determines that the SIP session concerned continues.

On the other hand, when the communication is disconnected due to occurrence of anomaly in the multifunctional peripheral device 102 (S608), the multifunctional peripheral device 101 never receives a 200_OK response from the multifunctional peripheral device 102 even if transmitting the Re-Invite request to the multifunctional peripheral device 102 (S609). Accordingly, when a response from multifunctional peripheral device 102 has not been received within the failure determination time 407, the multifunctional peripheral device 101 determines that the SIP session continuity is lost, transmits a Bye request to the multifunctional peripheral device 102 (S610), and performs an SIP session disconnection process.

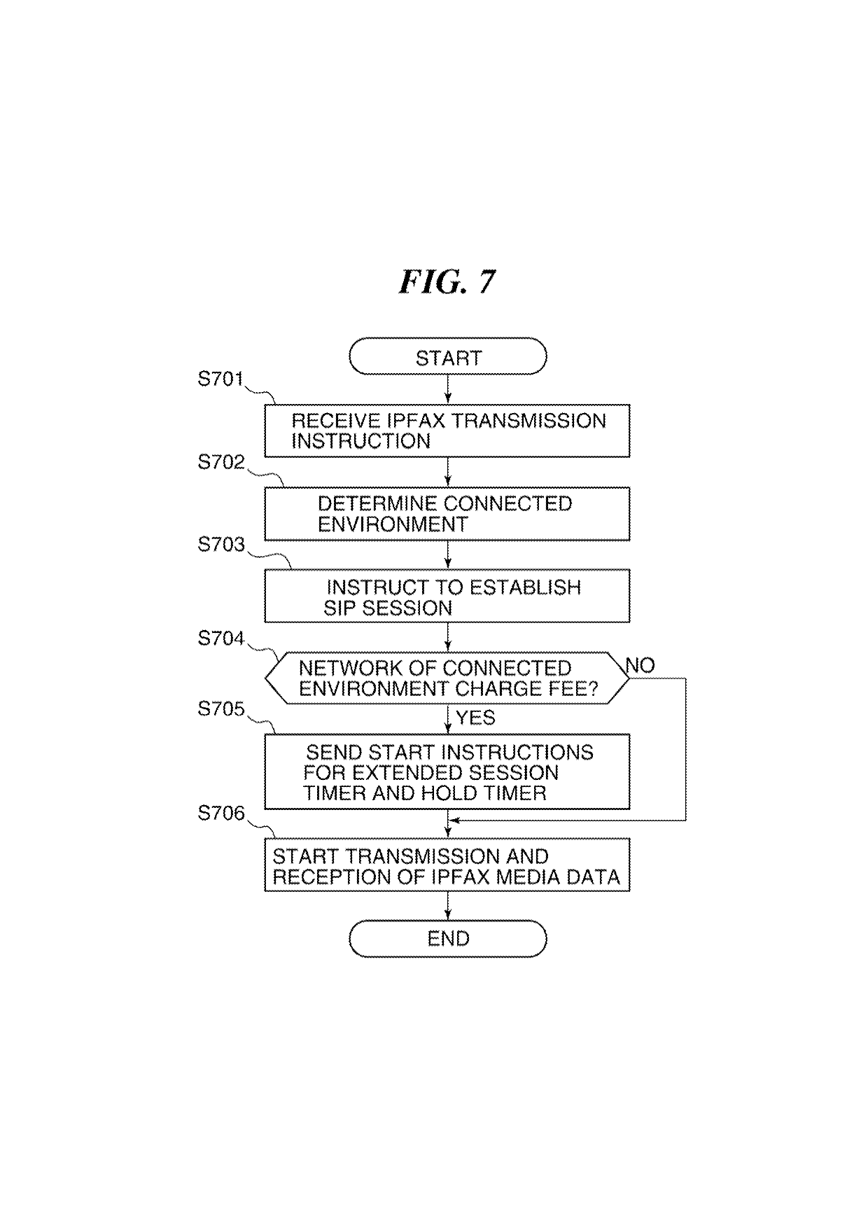

FIG. 7 is a flowchart showing an IPFAX transmission process executed by the multifunctional peripheral device 101. This process is achieved because the CPU 202 reads a control program from the ROM 203 to the RAM 204 and executes the control program. In this embodiment, a description assumes that the SIP URI of the multifunctional peripheral device 102 that is a communicated destination is “sip:04411112222”.

In step S701, when receiving an IPFAX transmission instruction from UI module 305, the command transceiver module 303 transmits a connected-environment determination request and the transmission destination SIP URI to the connected-environment-determination module 304.

In the next step S702, the connected-environment-determination module 304 determines a connected environment from the connection condition 403 of the connected environment information list 401 based on the character string following the string “sip:” of the transmission destination SIP URI. Then, the connected-environment-determination module 304 sends the connected environment information (the fee 404, the charging unit time 405, the continuity determination time 406, the failure determination time 407, and the IP address 408) corresponding to the determined connected environment to the command transceiver module 303. In this embodiment, since the destination SIP URI begins from “0”, the connected-environment-determination module 304 determines that the connected environment is “NW1”, and sends the connected environment information corresponding to “NW1” to the command transceiver module 303.

In the next step S703, the command transceiver module 303 sends the transmission destination SIP URI and the IP address 408 of the gateway device to the SIP control module 301, and instructs to establish an SIP session. The SIP control module 301 transmits the Invite request addressed to the transmission destination SIP URI to the IP address of the gateway device through the network I/F control unit 209, and performs a SIP session establishment process to the multifunctional peripheral device 102. When the SIP session is established, the SIP control module 301 notifies such a state to the media control module 302 and the command transceiver module 303.

In step S704, the command transceiver module 303 determines whether the network of the connected environment determined in the step S702 charges a fee. When it is determined that the network charges a fee, the process proceeds to step S705. On the other hand, when it is determined that the network does not charge a fee, the process proceeds to step S706. Specifically, the command transceiver module 303 determines whether the fee 404 in the connected environment information that is received from the connected-environment-determination module 304 is “CHARGED” or “UNCHARGED”. The process proceeds to the step S705 in the case of “CHARGED”, and the process proceeds to the step S706 in the case of “UNCHARGED”.

In the step S705, the command transceiver module 303 sends the charging unit time 405, the continuity determination time 406, the failure determination time 407, and sends start instructions for the extended session timer and the hold timer to the session continuity determination module 308. The session continuity determination module 308 instructs the extended-session-timer-control module 306 and the hold-timer control module 307 to start timers.

In the step S706, the media control module 302 starts transmission and reception of the IPFAX media data on the SIP session established in the step S703 through the network I/F control unit 209.

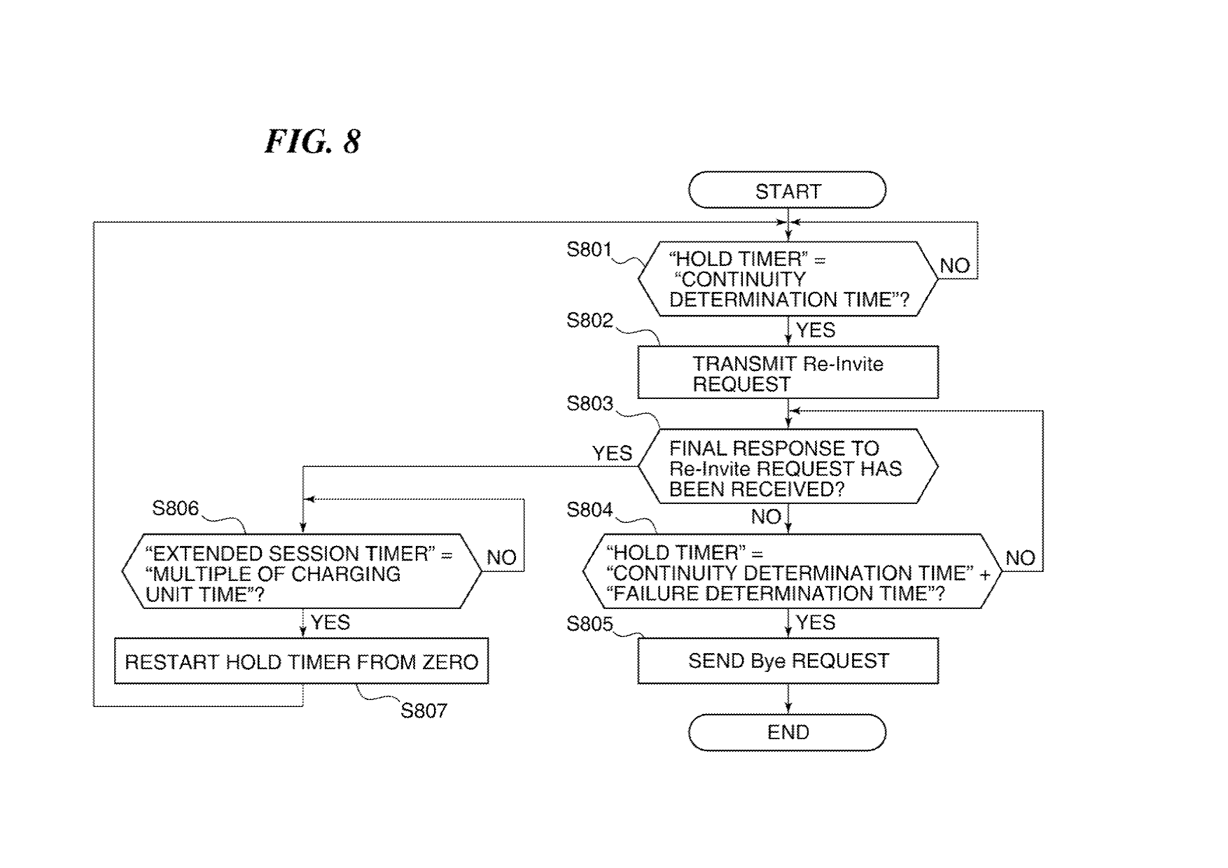

Next, the continuity determination process for the SIP session after starting the extended session timer and the hold timer in the step S705 in FIG. 7 will be described with reference to FIG. 8.

FIG. 8 is a flowchart showing the continuity determination process for the SIP session executed by the multifunctional peripheral device 101. This process is achieved because the CPU 202 reads a control program from the ROM 203 to the RAM 204 and executes the control program.

In step S801, the hold-timer control module 307 waits until the hold timer reaches the continuity determination time 406 (first predetermined time). When it is determined that the hold timer reached, the process proceeds to step S802.

In the step S802, the hold-timer control module 307 sends a sending request of a Re-Invite request to the command transceiver module 303. The command transceiver module 303 sends a Re-Invite transmission instruction to the SIP control module 301, and the SIP control module 301 transmits a Re-Invite request to the multifunctional peripheral device 102 through the network I/F control unit 209.

In step S803, the SIP control module 301 determines whether the final response to the Re-Invite request has been received through the network I/F control unit 209. When it is determined that the final response has been received, the process proceeds to step S806. Otherwise, the process proceeds to step S804.

In the step S804, the hold-timer control module 307 determines whether the hold timer reached at the time (second predetermined time) that is the sum of the continuity determination time and the failure determination time. The process in the step S804 is an example of a response determination unit. When it is determined that the timer reached, the process proceeds to step S805. Otherwise, the process returns to the step S803. In this embodiment, it is determined whether the response to the Re-Invite request has been received within the second predetermined time that is registered in the connected environment information list 401.

In the step S805, the hold-timer control module 307 determines that the continuity of the SIP session is lost, and sends a disconnect request of the SIP session concerned to the command transceiver module 303. When the command transceiver module 303 sends a Bye request transmission instruction to the SIP control module 301, the SIP control module 301 sends the Bye request through the network I/F control unit 209, and finishes this process by disconnecting the SIP session. The process in the step S805 is an example of a communication control unit.

In the step S806, the extended-session-timer-control module 306 determines whether the extended session timer reached the multiple of the charging unit time. When it is determined that the timer reached, the extended-session-timer-control module 306 notifies the hold-timer control module 307 of such a status, and the process proceeds to step S807.

In the step S807, the hold-timer control module 307 restarts the hold timer from zero, and the process returns to the step S801.

As described above, when the multifunctional peripheral device 101 communicates with the multifunctional peripheral device 102 by a predetermined communication protocol, it is determined whether the network used for communication charges a fee. And when the network charges a fee, the continuity of the communication is checked at constant time intervals. According to the checking result, the communication is finished when the communication does not continue. Accordingly, ineffectual process and load are reduced by checking continuity of a SIP session depending on whether a network charges a fee or not.

Although the above-mentioned embodiment described the case where the present invention is applied to the multifunctional peripheral device 101 that is a copier, the scope of the present invention is not limited to this. The present invention can be applied to any communication device as long as it has an IPFAX-communication function.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-140800, filed on Jun. 22, 2012, which is hereby incorporated by reference herein in its entirety.

What is claimed is:

1. A communication device that communicates with another communication device by a predetermined communication protocol, comprising:
a determination unit configured to determine whether a network used for communication charges a fee or not;
a checking unit configured to check whether the communication continues when said determination unit determines that the network charges a fee; and
a communication control unit configured to finish the communication when said checking unit determines that the communication does not continue.

2. The communication device according to claim 1, further comprising:
a registration unit configured to register connected environment information of the network used for the communication,
wherein said determination unit determines based on information showing whether the network charges a fee or not that is registered in the connected environment information by said registration unit.

3. The communication device according to claim 1, wherein said checking unit comprises:
a transmission unit configured to transmit a response request every first predetermined time to the other communication device, and
a response determination unit configured to determine whether a response is received within second predetermined time to the response request transmitted,
wherein said checking unit determines that the communication does not continue when a response is not received within the second predetermined time.

4. The communication device according to claim 1, wherein the predetermined communication protocol is a Session Initiation Protocol.

5. The communication device according to claim 1, wherein the communication device is connected to the network through a gateway device.

6. The communication device according to claim 1, wherein the communication with the other communication device is an IPFAX communication.

7. The communication apparatus according to claim 1, further comprising:
a reading unit configured to read an image on an original and to generate image data.

8. The communication device according to claim 1, further comprising:
a printing unit configured to print image data.

9. A control method for a communication device that communicates with another communication device by a predetermined communication protocol, the control method comprising:
a determination step of determining whether a network used for communication charges a fee or not;
a checking step of checking whether the communication continues when it is determined that the network charges a fee in said determination step; and
a communication control step of finishing the communication when it is determined that the communication does not continue in said checking step.

10. The control method for the communication device according to claim 9, further comprising:
a registration step of registering connected environment information of the network used for the communication,
wherein it is determined in said determination step based on information showing whether the network charges a fee or not that is registered in the connected environment information in said registration step.

11. The control method for the communication device according to claim 9, wherein said checking step comprises:
a transmitting step of transmitting a response request every first predetermined time to the other communication device, and
a response determination step of determining whether a response is received within second predetermined time to the response request transmitted,
wherein it is determined that the communication does not continue when a response is not received within the second predetermined time in said checking step.

12. A non-transitory computer-readable storage medium storing a control program causing a computer to execute a control method for a communication device that communicates with another communication device by a predetermined communication protocol, the control method comprising:
a determination step of determining whether a network used for communication charges a fee or not;
a checking step of checking whether the communication continues when it is determined that the network charges a fee in said determination step; and
a communication control step of finishing the communication when it is determined that the communication does not continue in said checking step.

13. The control program according to claim 12, wherein the control method further comprising:
a registration step of registering connected environment information of the network used for the communication,
wherein it is determined in said determination step based on information showing whether the network charges a fee or not that is registered in the connected environment information in said registration step.

14. The control program according to claim 12, wherein said checking step comprises:
a transmitting step of transmitting a response request every first predetermined time to the other communication device, and
a response determination step of determining whether a response is received within second predetermined time to the response request transmitted,
wherein it is determined that the communication does not continue when a response is not received within the second predetermined time in said checking step.
